(19) United States
(12) Patent Application Publication
(10) Pub. No.: US 2007/0214237 A1
(43) Pub. Date: Sep. 13, 2007

(54) Systems and Methods of Providing Web Content to Multiple Browser Device Types

(75) Inventors: Jeffrey M. Stibel, Atlanta, GA (US); Vikas Rijsinghani, Atlanta, GA (US); Sharon Harris, Atlanta, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: WEB.COM, INC., Atlanta, GA (US)

(21) Appl. No.: 11/623,368

(22) Filed: Jan. 16, 2007

Related U.S. Application Data
(60) Provisional application No. 60/780,805, filed on Mar. 10, 2006.

(51) Int. Cl. G06F 15/16; G06F 17/00

(52) U.S. Cl. 709/217; 715/511; 715/530

(57) ABSTRACT

Methods and systems for providing information to geographically proximate client are disclosed. One method includes: receiving an instruction to associate a geographic location with a web page; in response to the instruction, associating the location with the web page; associating content with the location; and when a mobile device comes into proximity to the location, sending the content to a recipient determined by previously stored contact information. One system includes means for receiving an instruction to associate a geographic location with a web page, and means for, in response to the instruction, associating the geographic location with the web page. The system further includes means for associating content with the geographic location and means for detecting a mobile device in proximity with the geographic location. The system further includes means, responsive to the means for detecting, for sending the content to a recipient determined by previously stored contact information.

### CROSS REFERENCE TO RELATED APPLICATIONS

This application claims the benefit of provisional application U.S. Ser. No. 60/780,805, filed Mar. 10, 2006, which is entirely incorporated by reference herein.

### FIELD OF THE DISCLOSURE

The present disclosure relates to providing web content, and more specifically, to systems and methods for providing web content to multiple browser device types.

### BACKGROUND

Many types of devices are now available which can access the Internet and the World-Wide Web. These devices vary greatly in their capabilities and characteristics. A user accessing the web from his office through a desktop or notebook personal computer has a relatively large screen and relatively high bandwidth. A user accessing the web through a notebook with a wireless local area network (LAN) has the same screen size but lower bandwidth. Personal digital assistants (PDAs) and phones have small screens, and access to the web through a wireless wide-area network (WAN) provides lower bandwidth than does a wireless LAN.

A website that is optimized for one kind of computing device may deliver suboptimal performance to other kinds of computing devices. Therefore, website designers who wish to provide optimal access for many different types of devices must design and maintain many different versions of the website, one for each device type. Existing solutions require the website designer to choose content that is appropriate for each device type, to design device-specific web pages that have a layout appropriate for a particular device type, and to place the device-specific content on the device-specific page. With such a process, it is difficult to design and maintain a website. Therefore, a need exists to address these and other deficiencies.

### SUMMARY

Methods and systems for providing information to geographically proximate client are disclosed herein. One exemplary method, among others, includes: receiving an instruction to associate a geographic location with a web page; in response to the instruction, associating the geographic location with the web page; associating content with the geographic location; and when a mobile device comes into proximity to the geographic location, sending the content to a recipient determined by previously stored contact information.

One exemplary system, among others, includes: means for receiving an instruction to associate a geographic location with a web page, and means for, in response to the instruction, associating the geographic location with the web page. The system further includes means for associating content with the geographic location and means for detecting a mobile device in proximity with the geographic location. The system further includes means, responsive to the means for detecting, for sending the content to a recipient determined by previously stored contact information.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure.

FIG. 1 is a block diagram of an environment in which one embodiment of a system and method for providing web content to multiple browser device types is located.

FIG. 2 is a data flow diagram illustrating the process of combining a web site template with web content.

FIG. 3 is a block diagram depicting an exemplary set of web site templates.

FIG. 4 is a block diagram depicting the relationship between a master template and device-specific template versions.

FIG. 5 is a data flow diagram illustrating the process of transforming a master template web page into a device-specific template web page.

FIG. 6 illustrates web content items.

FIG. 7. is a data flow diagram illustrating the process of transforming an intermediate template web page into a device-specific template web page.

FIG. 8 is a flowchart of a process by which a web site designer creates a web site with device-specific versions.

FIG. 9 is a message diagram showing the interaction between Web server and browser device.

FIG. 10 is a message diagram showing the interaction between another embodiment of a Web server and a browser device.

FIG. 11 is a hardware block diagram of a general-purpose computer that can be used to implement the systems and methods disclosed herein.

### DETAILED DESCRIPTION

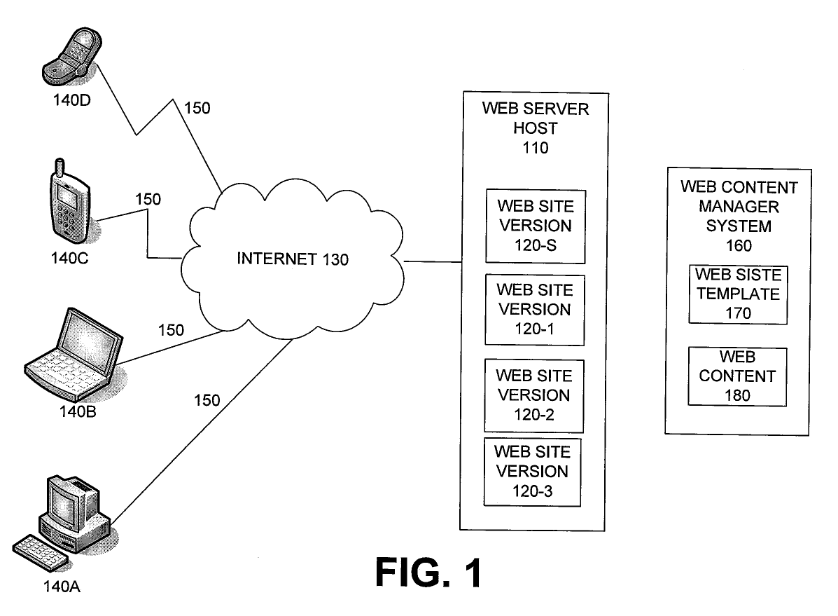

FIG. 1 is a block diagram of an environment in which one embodiment of a system and method for providing web content to multiple browser device types is located. Web server 110 hosts a web site 120, and is connected to the Internet 130, making web site 120 is accessible to Internet users. Each of devices 140 has access to web site 120 through a browser 150 and an Internet connection 160. Examples of communication characteristics include bandwidth and latency. Examples of display characteristics include screen size, screen resolution, and number of colors. Some of the devices 140 are portable, or mobile, and the term “mobile web client” will be used herein to refer to such mobile devices with browser capabilities.

Devices 140 differ in their communication, display, memory, storage, and/or interactivity characteristics. In the example of FIG. 1, device 140A has a high-speed connection to the Internet, device 140B has a medium-speed Internet connection, and devices 140C and 140D have low-speed connections. Devices 140A and 140B have full-size color screens, while device 140C has a smaller screen, and device 140D has an even smaller screen. Devices 140A and 140B have full-size traditional keyboards, while device 140C has a different, smaller keyboard, and device 140D has a number pad instead of a keyboard.

The browsers 150 may also have different features and capabilities. Browsers 150 may differ in the protocols and markup languages supported (e.g., HTTP, HTTPS, XML, HTML, WAP, etc.) browsers 150 may also differ in the types of graphics, images, audio, and/or multimedia content supported (e.g., JPEG, GIF, PNG, AVI, Flash, MP3, WAV, etc.).

Web server 110 maintains multiple versions (120-S, 120-1, 120-2, 120-3) of the website, each suitable for a different type of device. When one of devices 140 accesses web site 120, Web server 110 determines which of the web site versions (120-S, 120-1, 120-2, 120-3) is appropriate, based on characteristics of the device 140. Web server 110 then serves web pages from the appropriate version of that web site.

Web site versions 120-S, 120-1, 120-2, 120-3 are produced by a web content manager system 170. Each of Web site versions 120-S, 120-1, 120-2, 120-3 is created by web content manager system 170 from a web site template 180 selected by a web designer, in combination with web content 190 provided by the web designer.

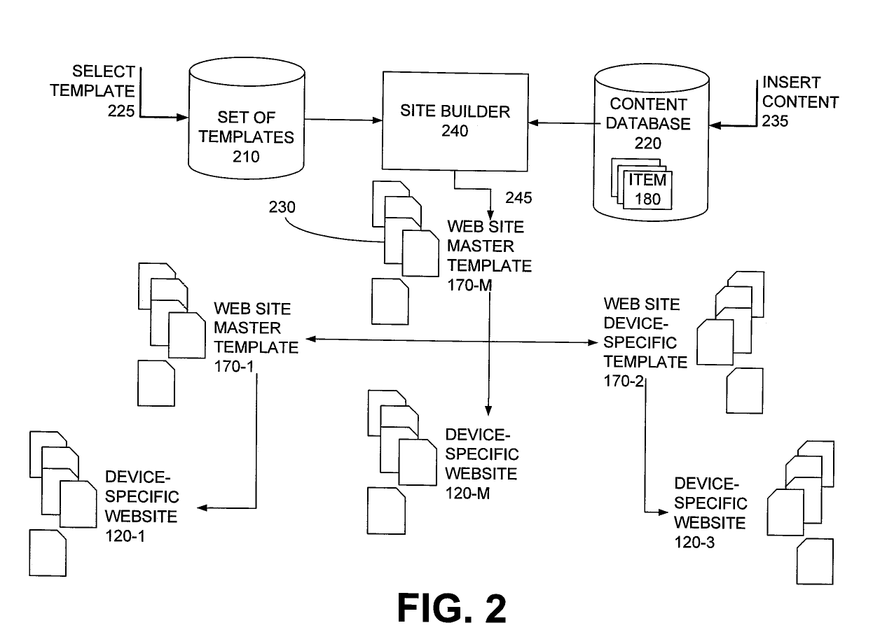

FIG. 2 is a data flow diagram illustrating the process of combining a web site template 180 with web content 190. Web content manager system 170 includes a set of stored web site templates 210 and a web content database 220. A web designer interacts with web content manager system 170 to select (225) one of the set of stored web site templates 210 for use in web site 120. Web site template 180 is made up of a collection of base web pages 230 with placeholders for customizable content. Web site template 180 also controls the visual appearance of these web pages. Web site template 180 thus provides the web designer with a starting point for web site 120, which can then be customized.

One of the ways the web designer can customize web site 120 is to insert (235) items of web content 190 from web content database 220 into particular pages 230 of web site template 180. When a web content item 190 is inserted, web content manager system 170 updates the placeholder on the page 230 in web site template 180. Examples of web content 190 include text, images, video, audio, hyperlinks, applets, etc. A person of ordinary skill in the art should be familiar with these and other types of web site content. These web content items 190 are stored in web content database 220. In some embodiments, web content items 190 are created by another program, and in other embodiments web content items 190 are created by another component of web content manager system 170.

A site builder component 240 creates (245) multiple versions 120-S, 120-1, 120-2, 120-3 of the web site from web site template 180 and web content database 220. Each version 120-x is suitable for a different set of device characteristics.

To accomplish this, site builder 240 uses a collection of device-specific template versions 180-1, 180-2, 180-3. The template seen by the web site designer can be viewed as a master template 180M. Site builder 240 derives template versions 180-1, 180-2, 180-3 from master template 180M before building the web site versions 120-x. Site builder 240 combines web content items 190 with master template 180M to produce web pages suitable for a standard browser device, such as a personal computer (PC). Site builder 240 combines web content items 190 with each of the other template versions (180-1, 180-2, 180-3) to produce web pages that are suitable for other devices, with characteristics and/or capabilities that differ from those of a standard browser device.

In one embodiment, the process of deriving template versions 180-1, 180-2, 180-3 from master template 180M is done as part of the overall process of building of multiple web site versions 120-S, 120-1, 120-2, 120-3, in response to a request from the website designer. In another embodiment, the creation of master template 180M, template versions 180-1, 180-2, 180-3, and web site version 120-S, 120-1, 120-2, 120-3 are performed as discrete steps. This second embodiment produces template versions 180-1, 180-2, 180-3 as an intermediate step, which allows the website designer to make changes to one or more of the derived template versions 180-1, 180-2, 180-3 produced by site builder 240.

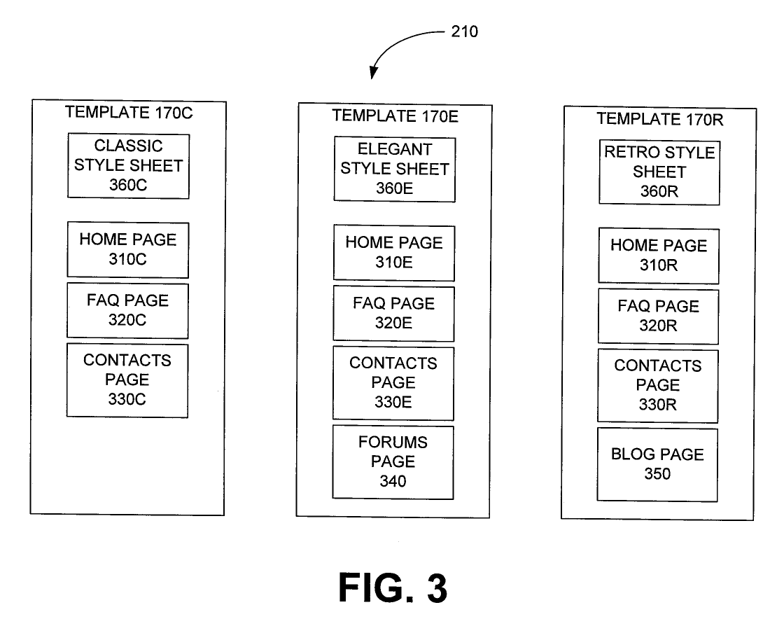

Web site templates and template versions will now be discussed in more detail. FIG. 3 is a block diagram depicting an exemplary set of web site templates. This diagram is not intended to provide a detailed representation of actual web pages, but merely to illustrate the concept that templates include web pages. Furthermore, a person of ordinary skill in the art should understand that a web site template includes hyperlinks between the pages in the template, even though such hyperlinks are not represented in this diagram.

As can be seen in FIG. 3, the templates 180 differ in visual appearance and in which pages are included. Template set 210 includes a template 180C which includes three web pages: home page 310C; frequently asked questions (FAQ) page 320C; and contacts page 330C. Template set 210 also includes two other templates, 180E and 180R. Templates 180E and 180R include a home page (310E, 310R), a FAQ page (320E, 320R), and a contacts page (330E, 330R). Template 180E includes a forums page 340 which is not present in the other templates, while template 180R includes a blog page 350 which is not present in the other templates.

Each template 180 also includes a style sheet 360: template 180C includes a “classic” style sheet 360C; template 180E includes an “elegant” style sheet 360E; and template 180R includes a “retro” style sheet 360R. The use of style sheets to impose a common visual appearance on a set of web pages should be familiar to a person of ordinary skill in the art. In another embodiment (not shown), formatting and visual appearance of pages within a template are encoded directly in the pages themselves, techniques which should be familiar to a person of ordinary skill in the art.

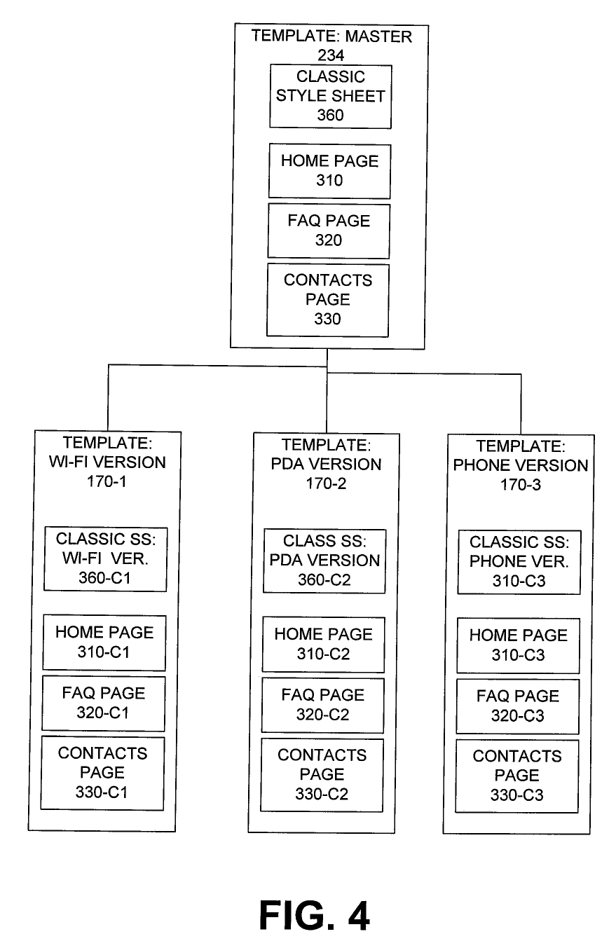

FIG. 4 is a block diagram depicting the relationship between master template 180M and template versions 180-x. The example web site template 180 shown in FIG. 4 has three device-specific versions: a “WiFi” version 180-1, a “PDA” version 180-2, and a “phone” version 180-3.

As can be seen in FIG. 4, each contains a different style sheet, namely, a device-specific version of the “classic” style sheet 360C which is present in master template 180M. Thus, WiFi template 180-1 contains a Classic WiFi style sheet 360C-1, PDA template 180-2 contains a Classic PDA style sheet 360C-1, and Phone template 180-3 contains a Classic Phone style sheet 360C-3. Although details of the device-specific style sheets are not shown, a person of ordinary skill in the art should understand that since style sheets control the visual appearance of a web page within a browser, a device-specific style sheet can be used to tailor a page for display on a particular browser device, by controlling characteristics such as: font sizes; color; number of characters per line; and number of, size of, and resolution of graphic images displayed on a page, etc.

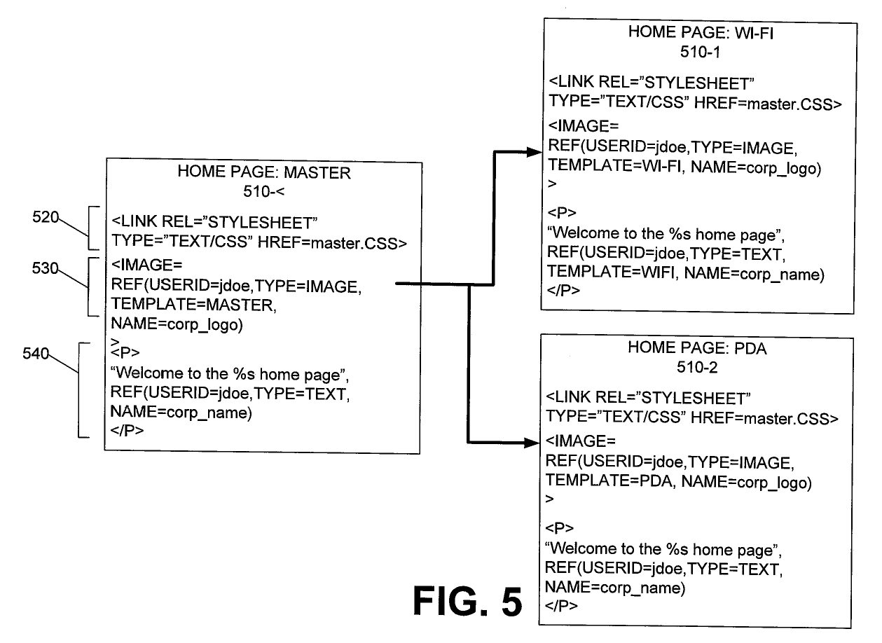

As described earlier in connection with FIG. 2, web content manager system 170 derives template versions 180-1, 180-2, 180-3 from master template 180M. FIG. 5 is a data flow diagram illustrating this process of transforming a master template web page 510M in into a device-specific template web page 510-x. In summary, this involves replacing references to the master template with references to the appropriate device-specific template. The web pages illustrated in FIG. 5 contain pseudo code rather than actual browser code (e.g., Hypertext Markup Language or HTML), but such a representation should be understandable by a person of ordinary skill in the art.

The example of FIG. 5 shows two template pages (510-1 and 510-2) being produced from master template web page 510-M. Note that these pages (510-M, 510-1, 510-2) are intermediate representations of a web page, still in partial template form, and are not meant to be rendered by a browser. Instead, site builder 240 will further process these template web pages (510-M, 510-1, 510-2), combining each with web content items 190 to produce final web pages 230 which are published to become one of Web site versions 120-S, 120-1, 120-2, 120-3.

The example master template web page 510-M contains several sections, introduced by tags: a link section 520; an image section 530; and a text section 540. From master template web page 510-M, web content manager system 170 produces a corresponding intermediate device-specific web page 510-1, with corresponding sections. The Link section 520 contains a reference to the style sheet to be used for the web page 510. Link section 520-M therefore refers to style sheet “master.css.” web content manager system 170 processes section 520-M and produces a Link section 520-1 in page 510-1 that refers to “wifi.css” instead, since page 510-1 is part of the WiFi-specific template 180-1. Similarly, web content manager system 170 produces a Link section 520-2 in page 510-2 that refers to “pda.css.”

Other references to the master template are also replaced appropriately. Image section 530-M contains the string “TEMPLATE=MASTER”, so corresponding section 530-1 is changed to “TEMPLATE=WIFI” and corresponding section 530-2 is changed to “TEMPLATE=PDA”. The use of the keyword “TEMPLATE=” is but one way to effect a replacement of master template references with device-specific references, and the person of ordinary skill in the art should recognize there are many alternatives, all considered to be in the scope of this disclosure.

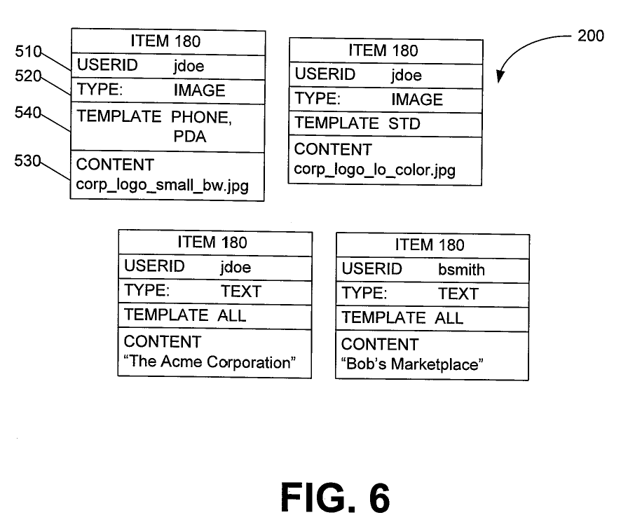

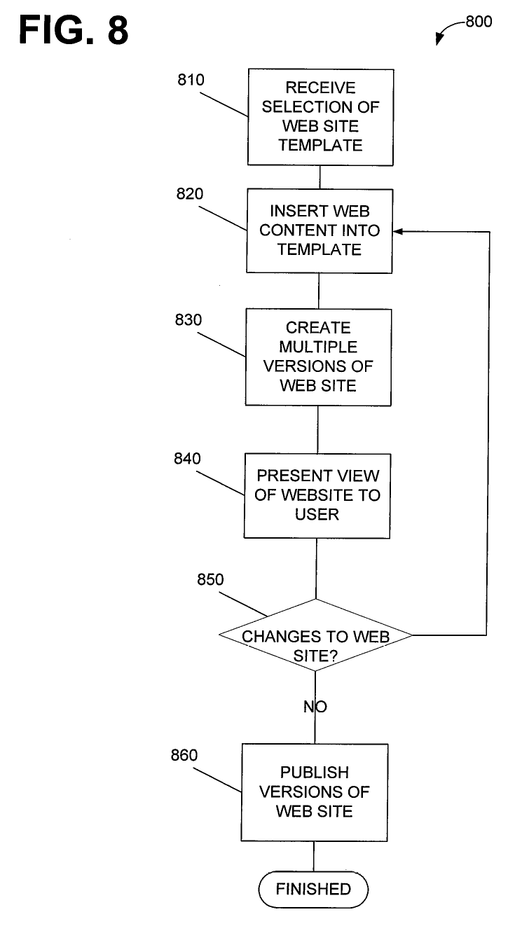

As discussed earlier, the template web pages (510-M, 510-1, 510-2) produced by the transformation process of FIG. 5 are further processed by combining each template web page with web content items 190. FIG. 6 illustrates several web content items 190. The Name field 610 identifies the content item. User field 620 indicates which user entered the content item, which may also be viewed as the owner of the item. The Type field 630 indicates the content type, for example, text, graphic, video, sound, etc. The Content field 640 stores either the content itself (e.g., a string), or a reference to the content (e.g., name of a file containing the content). The Template field 650 indicates one or more templates for which this content item is appropriate. The determination of which content is appropriate for a template will be discussed later in connection with FIG. 8.

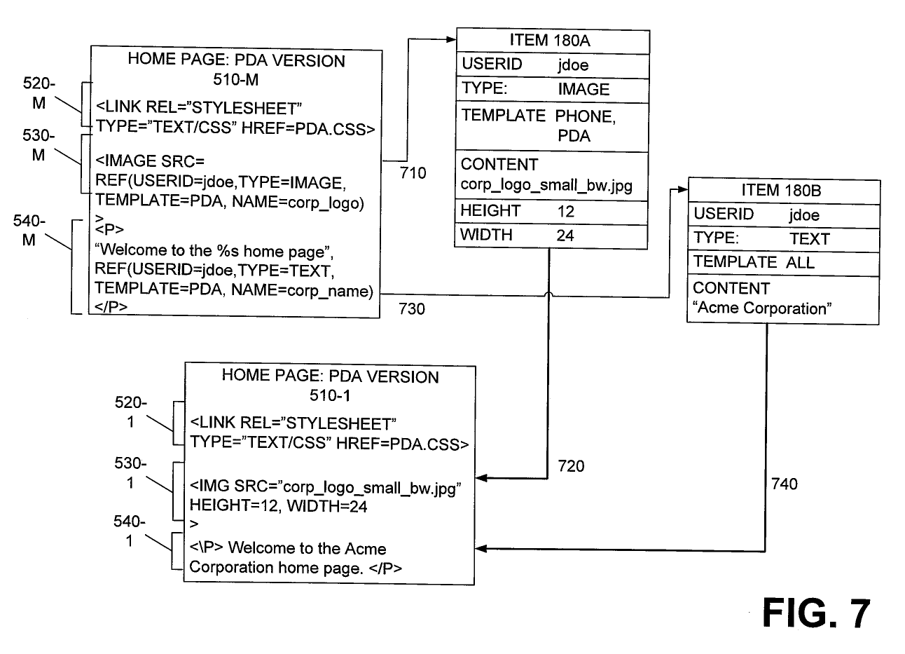

To transform an intermediate template web page 510 (either master or a device-specific) into a device-specific template web page 510-x, web content manager system 170 extracts items 190 from web content database 220 using one or more of the fields as a look-up key. A combined key using Name 610, User 620 and Template 630 is used in one embodiment, while another embodiment uses UserId 620, Template 630, and Type 640 as a combined key, but a person of ordinary skill in the art should recognize that other keys are also possible. The returned Content is inserted as a replacement for the placeholder in the template. This process will now be described in connection with the data flow diagram of FIG. 7.

In each template web page 510, placeholder references using the “REF” directive are processed as follows. The placeholder directive (“REF”) includes all the information needed to identify the corresponding content from web content item 190 from web content database 220. Once identified, the matching content 190 is retrieved (710) and used to replace (720) the placeholder. In some cases a complete replacement of the placeholder with the content is indicated, and in other cases string formatting directives (e.g., “% s”) are use to insert the placeholder into an existing string in the template web page 510.

In this example, the placeholder in Image section 530-M is “REF(Userid=jdoe,Type=Image, Template=Master, Name=Corp_Logo)”. Web content manager system 170 queries web content database 220 for an item with the specified UserId, Type, Template, and Name, and the matching item 190A is retrieved (710). In the example of FIG. 6, the matching Content is the filename “corp_logo_small_bw.jpg.” No string directive is present, so the entire placeholder is replaced (720) with this content. Any additional attributes of the matching Content are appended after the replacement. In this example, the image content also includes Height and Width attributes which are appended. The Image section 530-M is thus transformed from <IMAGE SRC=REF(USERID=jdoe, TYPE=IMAGE, TEMPLATE=PDA, NAME=corp_logo)> into <IMG SRC=“corp_logo_small_bw.jpg” HEIGHT=12, WIDTH=24>.

A similar transformation is performed on the Text section 540-M: Web content manager system 170 retrieves (730) the matching content item 190B, and Text section 540-M is modified (740) using this content. However, in the case of Text section 540-M, no additional attributes from the matching content are present, and a string directive is used to insert the placeholder in the middle of an existing string. Thus, Text section 540-M is transformed from <P>“Welcome to the % s home page”, REF(USERID=jdoe,TYPE=TEXT, NAME=corp_name)</P> to <P> Welcome to the Acme Corporation home page. </P>

FIG. 8 is a flowchart of a process 800, embodied by web content manager system 170, by which a web site designer creates a web site 120 with device-specific versions. Process 800 begins at block 810, where a web site designer selects a web site template 180. At block 820, the designer inserts web content items 190 into the pages of the selected web site template 180. At block 830, web content manager system 170 creates multiple versions (120-S, 120-1, 120-2, 120-3) of the web site using the web content items 190 and the selected web site template 180. At block 840, the designer may view any or all pages of the newly created standard version (120-S) of the web site.

At block 850, the designer is given the option of making changes to web site 120. Processing then continues at block 820 if the designer chooses to change the web content items 190 on the pages in web site 120, or at 810 if the designer chooses to make changes by selecting a different web site template 180 from the set of stored web site templates 210. The user may also add or remove individual pages in web site 120 (not shown). In some embodiments, these additional pages are created by another program, and in other embodiments additional pages are created by another component of web content manager system 170.

From the decision block at 850, if the designer does not wish to make changes to web site 120 then processing continues at block 860. At block 860, process 800 uploads the multiple versions (120-S, 120-1, 120-2, 120-3) of the web site to Web server 110. Next, at block 860, process 800 publishes the Web site versions 120-S, 120-1, 120-2, 120-3, making the pages of these sites available to devices through Internet 130.

As discussed earlier, Web server 110 determines which version of its hosted web site is appropriate for a given browser device, based on characteristics of the device 140. Web server 110 then serves web pages 230 from the appropriate version of that web site. Now that the process of creating multiple web site versions has been explained, the process of identifying which version is appropriate for a particular browser device will be described.

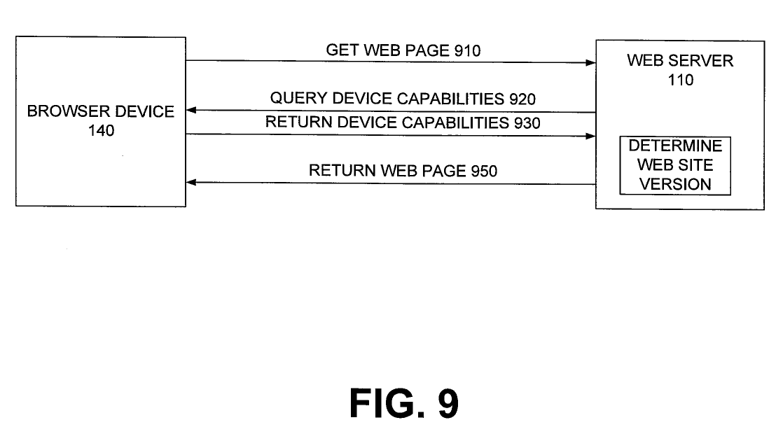

FIG. 9 is a message diagram showing the interaction between Web server 110 and browser device 140. Browser device 140 makes an initial request (910) for a specific web page (i.e., a uniform resource identifier). In response, and before providing the requested resource, Web server 110 queries (920) browser device 140 for its capabilities and/or characteristics. In response to the query, browser device 140 provides (930) a description of its capabilities. Web server 110 determines (940) which version (120-S, 120-1, 120-2, 120-3) of the web site is a match for these capabilities, and responds (950) to the original resource request (910) with the requested resource from the matching web site version 120-x.

In one embodiment, standard HTTP headers are used to convey device capabilities. Another embodiment conveys device capabilities using User Agent Profiles (UAProf) carried over HTTP Extensions. In yet another embodiment, Media Queries are used in conjunction with HTML4 or Cascading Style Sheets 2 (CSS2) to convey device capabilities.

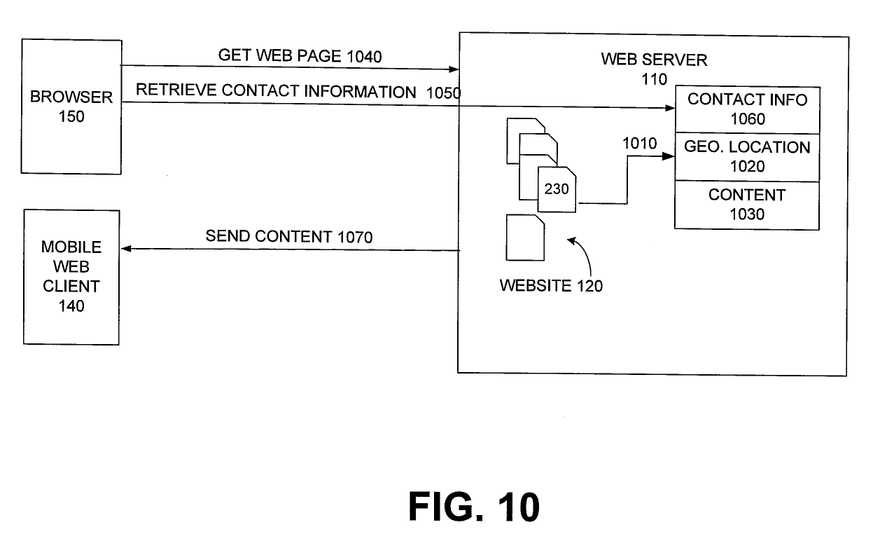

Another embodiment of Web server 110, which implements an information service that is triggered by geographic proximity, will now be described in connection with FIG. 10. A web site designer or administrator associates (1010) a geographic location 1020 with a web page 230 served by Web server 110, or with a web content item 190 that is part of a web page 230. The administrator also defines content 1030 to be sent to mobile devices coming into geographic proximity to geographic location 1020. This content 1030 is related to the geographic location 1020. For example, it may describe aspects of the geographic location: if the geographic location 1020 is a business district, the content 1030 may list the businesses in the district, and include descriptions, addresses, and operating hours for each; if the geographic location 1020 is a retail store, the content 1030 may include operating hours and store specials; if the geographic location 1020 is a restaurant, the content 1030 may include operating hours and a menu.

A browser 150 retrieves (1040) from Web server 110 a web page 230, or a web content item 190, that has an associated geographic location 1020. Web server 110 receives (1050) and stores contact information 1060 from browser 150. Contact information 1060 describes how a user of the browser 150 can be contacted electronically in the future. In various embodiments, contact information 1060 includes an e-mail address, a phone number, a text messaging identifier, or an Internet Protocol (IP) address. Contact information 1060 may also include user-identifying information such as a name or a login identifier. In some embodiments, contact information 1060 is provided automatically by the browser 150 upon retrieving the web page 230 or web content item 190. In other embodiments, retrieved web page 230 prompts the user of browser 150 to provide contact information 1060. Web server 110 stores contact information 1060 in association with the geographic location 1020.

When a mobile device 140 comes into proximity with geographic location 1020, Web server 110 is triggered to send (1070) the associated content 1030 to a recipient determined by previously stored contact information 1060. Note that contact information 1060 does not necessarily refer to the triggering mobile device 140. For example, contact information 1060 may apply to a user's mobile phone, while the mobile device 140 that triggers contact from Web server 110 may be the user's PDA. However, in some embodiments, the contact information 1060 does refer to the triggering mobile device 140. That is, the PDA triggers contact from Web server 110 and also receives the content 1030.

In some embodiments, Web server 110 is passive, and mobile device 140 notifies Web server 110 that of its proximity. In other embodiments, a component actively monitors for devices entering the area, and notifies Web server 110 when a device is nearby. In some of these active monitor embodiments, the monitoring component is associated with the owner/operator of the web page 230.

The geographic location 1020 may be specific, such as a street address or GPS coordinates, or may be more general, such as a business district, census tract, a zip code, a city, or a county. The measure of proximity may depend on the level of specificity with which geographic location 1020 was defined. For example, if geographic location 1020 was defined narrowly as a street address, the measure of proximity may be an area surrounding the street address. On the other hand, if geographic location 1020 was defined more broadly as a municipality, then the message may be triggered when mobile device 140 enters the boundaries of the municipality. Furthermore, the form which content 1030 takes depends on the type of contact information 1060, and in some cases, a message wrapper or “envelope” may be used to contain the content 1030. Thus, if contact information 1060 is an e-mail address, Web server 110 encloses the content 1030 within an e-mail message, and sends the e-mail message to the user. If contact information 1060 is a text message identifier, Web server 110 includes content 1030 within a short messages service (SMS) text message. If contact information 1060 is a phone number, Web server 110 delivers the content 1030 through a voice phone call. Such an embodiment may use pre-recorded messages or text-to-speech technology to generate the voice content. For an IP address, Web server 110 may “push” a web page containing the content 1030 to a browser within mobile device 140.

In one embodiment, this push is accomplished as follows. Before coming into proximity with geographic location 1020, the user views a web page in the browser 150 on the mobile device 140. The viewed web page is associated with the geographic location 1020, and contains a periodic refresh directive. Later, when mobile device 140 comes into proximity with geographic location 1020, Web server 110 makes updates to the associated web page. These updates customize the content of the web page based on the geographic location 1020. The periodic refresh on the page causes the browser 150 on mobile device 140 to eventually retrieve the page again from Web server 110, which in this case contains updated content based on the proximity to geographic location 1020.

In one example of the above-described information service triggered by geographic proximity, a retail store has a web site located on Web server 110. Within the web site are one or more web pages 230, each of which contains content that is specific to a physical store location. The retail store uses the above-described information service to provide consumers who come near a physical store location with information about that location, for example, operating hours, featured products, or current or upcoming sales. An interested consumer registers at the store's website through a browser, and provides contact information 1060 through which he can be contacted in the future, when that consumer is nearby one or more of the store's physical locations. Monitoring stations at the store locations notify Web server 110 when a mobile device 140 comes into proximity with geographic location 1020. If Web server 110 recognizes the mobile device 140 as one for which contact information 1060 is known, Web server 110 sends content 1030 to the consumer through mobile device 140. This inventive feature allows businesses who operate websites to push content to users who are likely to be receptive to receiving the information, since they are physically near a geographic location that is related to the website.

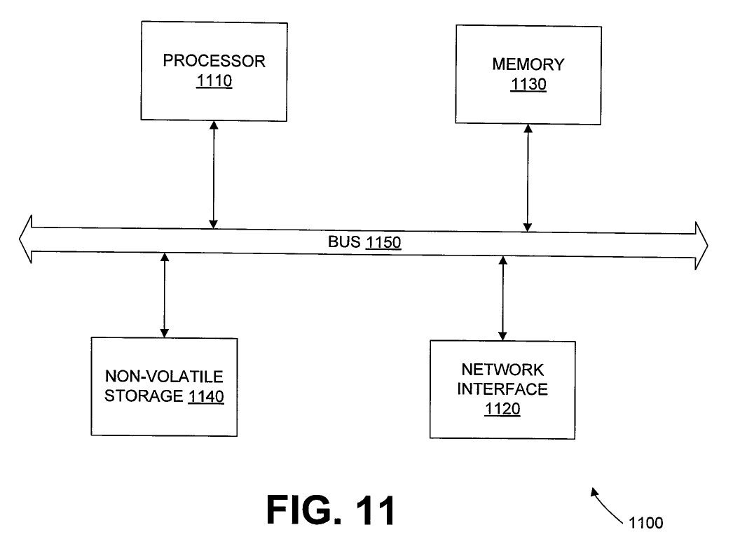

FIG. 11 is a hardware block diagram of a general-purpose computer 1100 that can be used to implement the systems and methods disclosed herein. The computer 1100 contains a number of components that are well known in the art of call center software, including a processor 1110, a network interface 1120, memory 1130, and non-volatile storage 1140. Examples of non-volatile storage include, for example, a hard disk, flash RAM, flash ROM, EEPROM, etc. These components are coupled via a bus 1150. The memory 1130 contains instructions which, when executed by the processor 1110, implement the methods and systems disclosed herein. Omitted from FIG. 11 are a number of conventional components, known to those skilled in the art that are unnecessary to explain the operation of the system 1100.

The systems and methods disclosed herein can be implemented in software, hardware, or a combination thereof. In some embodiments, the system and/or method is implemented in software that is stored in a memory and that is executed by a suitable microprocessor (pP) situated in a computing device. However, the systems and methods can be embodied in any computer-readable medium for use by or in connection with an instruction execution system, apparatus, or device. Such instruction execution systems include any computer-based system, processor-containing system, or other system that can fetch and execute the instructions from the instruction execution system. In other embodiments, the system and/or method is implemented in hardware, including, but not limited to, a programmable logic device (PLD), programmable gate array (PGA), field programmable gate array (FPGA) or an application-specific integrated circuit (ASIC).

In the context of this disclosure, a “computer-readable medium” can be any means that can contain, store, communicate, propagate, or transport the program for use by, or in connection with, the instruction execution system. The computer readable medium can be, for example but not limited to, a system or propagation medium that is based on electronic, magnetic, optical, electromagnetic, infrared, or semiconductor technology.

Specific examples of a computer-readable medium using electronic technology would include (but are not limited to) the following: an electrical connection (electronic) having one or more wires; a random access memory (RAM); a read-only memory (ROM); an erasable programmable read-only memory (EPROM or Flash memory). A specific example using magnetic technology includes (but is not limited to) a portable computer diskette. Specific examples using optical technology include (but are not limited to) optical fiber and compact disc read-only memory (CD-ROM).

Note that the computer-readable medium could even be paper or another suitable medium on which the program is printed. Using such a medium, the program can be electronically captured (using, for instance, optical scanning of the paper or other medium), compiled, interpreted or otherwise processed in a suitable manner, and then stored in a computer memory. In addition, the scope of the certain embodiments of the present invention includes embodying the functionality of the preferred embodiments of the present invention in logic embodied in hardware or software-configured mediums.

It should be noted that any process descriptions or blocks in flowcharts should be understood as representing modules, segments, or portions of code which include one or more executable instructions for implementing specific logical functions or steps in the process. As would be understood by those of ordinary skill in the art of the software development, alternate embodiments are also included within the scope of the disclosure. In these alternate embodiments, functions may be executed out of order from that shown or discussed, including substantially concurrently or in reverse order, depending on the functionality involved.

This description has been presented for purposes of illustration and description. It is not intended to be exhaustive or to limit the disclosure to the precise forms disclosed. Obvious modifications or variations are possible in light of the above teachings. The embodiments discussed, however, were chosen to illustrate the principles of the disclosure, and its practical application. The disclosure is thus intended to enable one of ordinary skill in the art to use the disclosure, in various embodiments and with various modifications, as are suited to the particular use contemplated. All such modifications and variation are within the scope of this disclosure, as determined by the appended claims when interpreted in accordance with the breadth to which they are fairly and legally entitled.

What I claim is:

1. A method of providing information to geographically proximate clients, the method comprising the steps of:
receiving an instruction to associate a geographic location with a web page;
in response to the instruction, associating the geographic location with the web page;
associating content with the geographic location; and
when a mobile device comes into proximity to the geographic location, sending the content to a recipient determined by previously stored contact information.

2. The method of claim 1, further comprising the step of:
when the mobile device comes into proximity with the geographic location, enclosing the content in a message wrapper and delivering the message to the recipient, the recipient determined by the previously stored contact information.

3. The method of claim 1, further comprising the step of:
when the mobile device comes into proximity with the geographic location, delivering an e-mail message containing the content to the recipient, the recipient determined by the previously stored contact information.

4. The method of claim 1, further comprising the steps of:
receiving contact information describing a mechanism for contacting a user; and
when the mobile device comes into proximity with the geographic location, using the received contact information to send the content to the user.

5. The method of claim 1, further comprising the step of:
receiving a user registration including contact information; and
storing the contact information.

6. The method of claim 1, further comprising the step of:
detecting the condition of the web client coming into proximity with the geographic location.

7. The method of claim 1, further comprising the step of:
receiving a notification, from a monitor, of the web client coming into proximity with the geographic location.

8. A computer-readable medium having a computer program for providing information to geographically proximate clients stored thereon, the computer program comprising logic for performing the steps of:
receiving an instruction to associate a geographic location with a web page;
in response to the instruction, associating the geographic location with the web page;
associating content with the geographic location; and
responsive to detecting a mobile device in proximity to the geographic location, sending the content to a recipient determined by previously stored contact information.

9. The computer-readable medium of claim 8, further comprising the step of:
responsive to the mobile device being in proximity with the geographic location, enclosing the content in a message wrapper and delivering the message to the recipient, the recipient determined by the previously stored contact information.

10. The computer-readable medium of claim 8, further comprising the step of:
when the mobile device comes into proximity with the geographic location, delivering an SMS message containing the content to the recipient, the recipient determined by the previously stored contact information.

11. The computer-readable medium of claim 8, further comprising the steps of:
receiving contact information describing a mechanism for contacting a user; and
when the mobile device comes into proximity with the geographic location, using the received contact information to send the content to the user.

12. The computer-readable medium of claim 8, further comprising the step of:
receiving a user registration including contact information; and
storing the contact information.

13. The computer-readable medium of claim 8, further comprising the step of:
detecting the condition of the web client coming into proximity with the geographic location.

14. The computer-readable medium of claim 8, further comprising the step of:
receiving a notification, from a monitor, of the web client coming into proximity with the geographic location.

15. A system of providing information to geographically proximate clients, the system comprising the steps of:
means for receiving an instruction to associate a geographic location with a web page;
means for, in response to the instruction, associating the geographic location with the web page;
means for associating content with the geographic location;
means for detecting a mobile device in proximity with the geographic location; and
means for sending the content to a recipient determined by previously stored contact information, responsive to the means for detecting.

16. The system of claim 15, further comprising:
means for enclosing the content in a message wrapper and delivering the message to the recipient, the recipient determined by the previously stored contact information, wherein the means for enclosing is responsive to the means for detecting.

17. The system of claim 15, further comprising:
means for pushing a web page containing the content to the recipient, the recipient determined by the previously stored contact information, wherein the means for pushing is responsive to the means for detecting.

18. The system of claim 15, further comprising:
means for receiving contact information describing a mechanism for contacting a user; and
when the mobile device comes into proximity with the geographic location, using the received contact information to send the content to the user.

19. The system of claim 15, further comprising:
means for receiving a user registration including contact information; and
means for storing the contact information.

20. The system of claim 15, further comprising:
means for receiving a notification, from a monitor, of the web client coming into proximity with the geographic location.
